(19) United States
(12) Patent Application Publication
(10) Pub. No.: US 2013/0067798 A1
(43) Pub. Date: Mar. 21, 2013

(54) FLY REPELLER

(71) Applicant: Steve KELTNER, Cardova, TN (US)

(72) Inventor: Steve KELTNER, Cardova, TN (US)

(21) Appl. No.: 13/555,448

(22) Filed: Jul. 23, 2012

Related U.S. Application Data
(60) Provisional application No. 61/536,152, filed on Sep. 19, 2011.

(51) Int. Cl. A01M 5/02; A01M 3/02

(52) U.S. Cl. 43/137; 43/142

(57) ABSTRACT

A fly repeller includes a housing; a motor contained within the housing; a rod having one end connected to the motor and rotatably driven by the motor, the rod extending from the one end through the housing to a distal end portion exterior to the housing; and plural arms fixed to and extending laterally from the distal end portion of the rod, wherein the arms are adjustable relative to the horizontal. The arm may be freely shaped by hand (manually) into a configuration which is held by the arms when rotated in use.

### CROSS-REFERENCE TO RELATED APPLICATION

This application claims priority, under 35 USC 119(e), of U.S. provisional patent application Ser. No. 61,536,152, filed Sep. 19, 2011.

### BACKGROUND OF THE INVENTION

Flies are exasperating little pests that pose a health risk or, at a minimum, a nuisance.

Whole industries have grown up to eradicate flies from our homes and gardens. From “humane” to more severe means, flies get poisoned, vacuumed, immobilized on sticky paper or even electrocuted (Zappers). A fly's existence in the home often ends with the leather slapping sound of a flyswatter.

The nuisance factor around food and drink outside the home (the patio at home or outdoor dining in restaurants) is particularly aggravating. While the fly population might be roughly calculated inside a building, all bets are off on the outside. Flies can just keep coming. The shooing away by waving of the hands or swinging of a swatter is disruptive and detrimental to the dining experience.

### SUMMARY OF THE INVENTION

The fly repeller of the present invention includes a motor, a housing for containing and supporting the motor with its armature oriented to rotate around an approximately vertical axis, a rod with one end coupled to the armature for rotation with the armature, the rod extending from the one end and through housing to a distal end portion exterior to the housing. At least two arms are fixed to and extend laterally from the distal end portion of the rod. The plural arms extend from the rod, away from each other, to distal ends which are adjustable relative to the horizontal.

In one type embodiment, the distal ends are made adjustable relative to the horizontal by adjustment or changing of a pivotal connection between inner ends of the arms and the distal end portion of the rod or a hub fixed to the distal end portion of the rod.

In another type embodiment, the arms are bendable by hand to bring the distal ends to a suitable vertical distance from a surface on which the housing is placed or to a level at a suitable vertical distance from food on a plate or a beverage container.

The arms may be blades of a conventional fan. Alternatively, the arms may have a swatter fan portion and a swatter arm portion joining the swatter fan portion to the distal end portion of the rod. In the latter alternative, the swatter arm portion either pivots at its point of connection with the rod or hub or is bendable by hand.

The housing is designed to hold the rod in a generally vertical orientation. Toward this end the housing is vertically elongated, extending from a base, which may include a suction cup or radially extending flange, to an upper end where the rod penetrates the housing.

Accordingly, the present invention provides a fly repeller including: a housing; a motor contained within the housing; a rod having one end connected to the motor and rotatably driven by the motor, the rod extending from the one end through the housing to a distal end portion exterior to the housing; and plural arms fixed to and extending laterally from the distal end portion of the rod, wherein the arms are adjustable relative to the horizontal.

Optionally, the arms of the fly repeller are independently adjustable relative to the horizontal.

In one embodiment of the present invention each of the plural arms is freely bendable to fix a distal end of the arm at any desired distance from a support surface on which the housing is placed. In another embodiment the arms are pivotally connected to the distal end of the rod. Of course the features of the two embodiments may be combined into a single embodiment.

Each arm may include a fan-shaped swatter end portion.

### BRIEF DESCRIPTION OF THE DRAWINGS

FIG. 1 is a side view, partially in cross-section, of a first embodiment of the present invention;

FIG. 2 is an enlarged view of the pivotal connection of the arms in the first embodiment of FIG. 1;

FIG. 3 is a side view of a modification of the first embodiment; and

FIG. 4 is a side view, in cross-section, of a second embodiment of the present invention.

### DESCRIPTION OF THE PREFERRED EMBODIMENTS

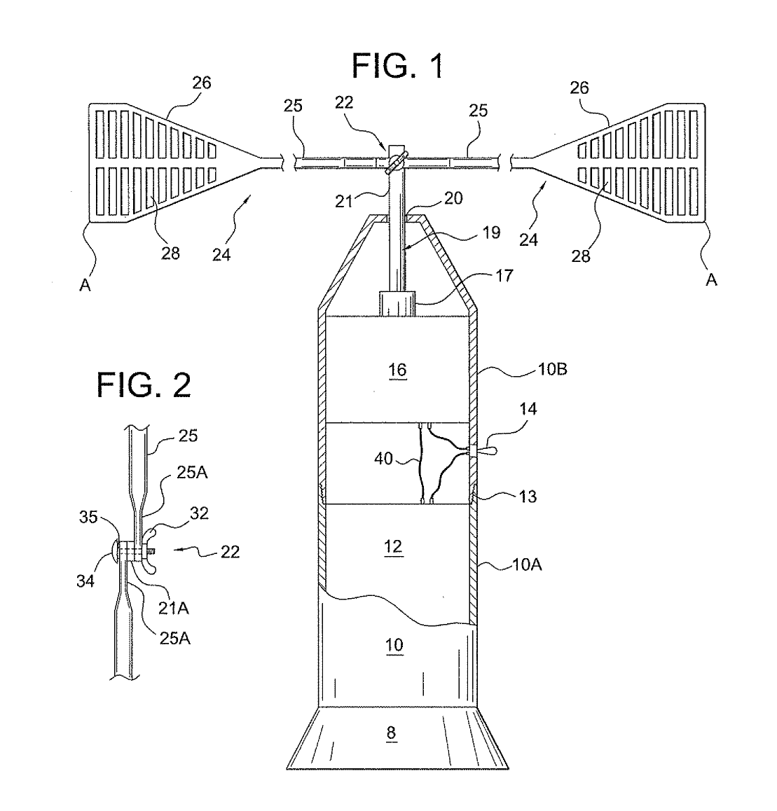

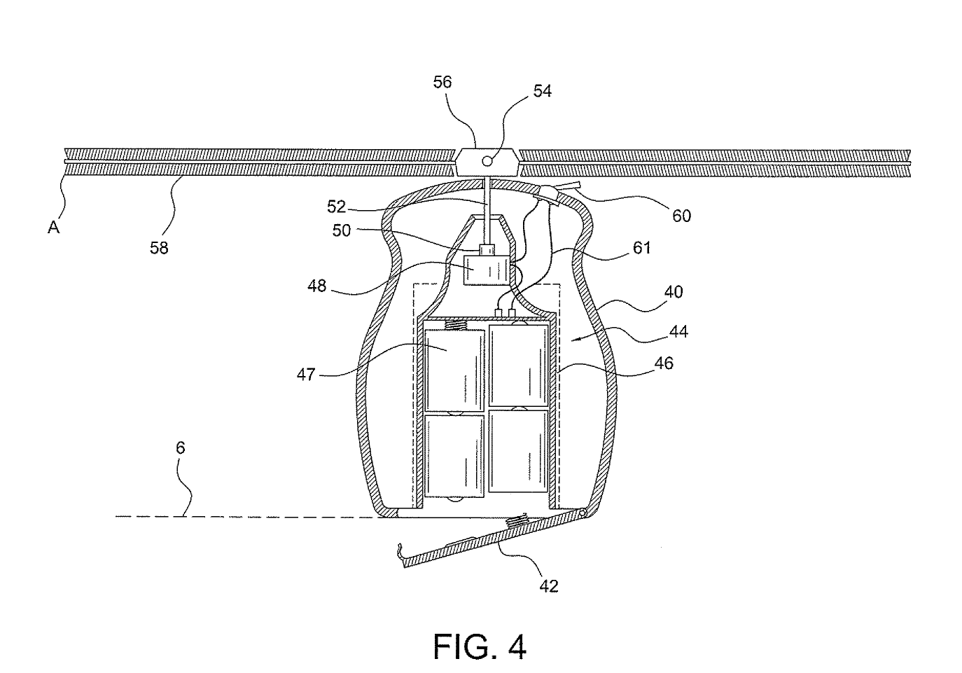

A first embodiment is illustrated in FIGS. 1 and 2. As shown in FIG. 1, a housing 10 has a flared base 8, which is optionally a suction cup, allowing it to stand vertically relative to an arbitrary surface, e.g., a table top. The housing 10 is shown as containing a DC motor 16 and a battery pack 12, e.g., a battery holder and batteries held therein, as shown in FIG. 4, providing power to the motor 16.

The circuit which supplies electricity from the battery pack 12 to the DC motor 16 includes a conventional toggle switch 14 for turning the motor 16 off and on. However, any conventional switch, such as a flashlight-type sliding switch, may be used. Instead of the battery pack 12, a sealed battery may be used. Further, an AC motor and cord may be substituted for the combination of the DC motor 16 and power pack 12. Other possibilities include combinations of a DC motor and an AC/DC transformer.

A lower end of a rod 19 is fixed to the armature of the motor 16 through a coupling 17, for rotation therewith, and extends through a bearing 20 in the housing 10 to a distal end portion 21 exterior to the housing 10.

In the embodiment of FIGS. 1 and 2, the arms 24 may be metal or plastic or a combination thereof. Each arm 24 includes an arm rod 25 and a fan blade portion or swatter portion 26, both of which are rigid or a combination of a rigid arm rod 25 and a flexible or less rigid blade or swatter portion 26. As shown in FIG. 1, the swatter portion 26 is a conventional fly swatter configuration, exemplified by a flexible plastic sheet with slot-shaped openings 28. The arm rod 25 may be round, oval or polygonal in cross-section or may be a flat strip of metal or plastic.

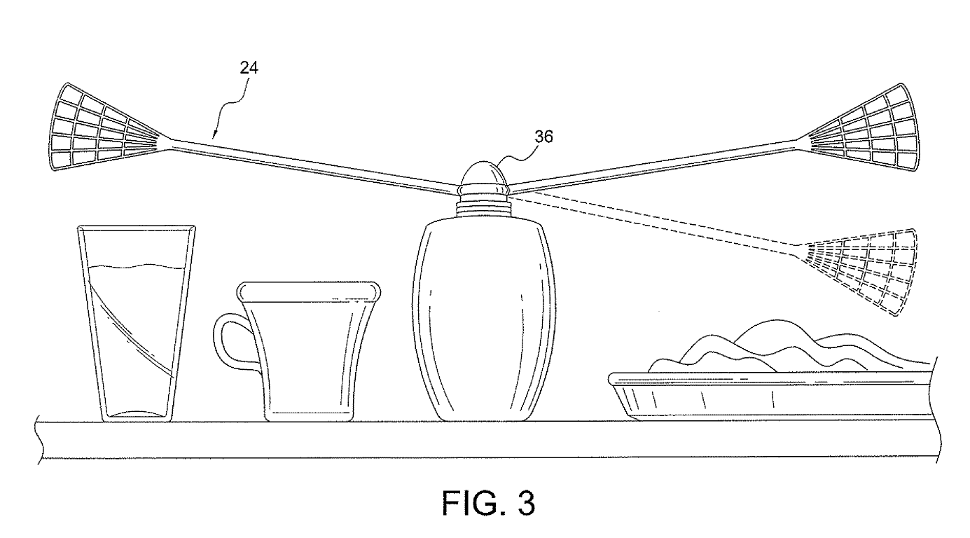

Each of the arm rods 25 has a flattened end portion 25A. The flattened end portions 25A are pivotally connected to a flattened end 21A of rod exterior portion 21 by a pivotal connection 22. The pivotal connection 22, as best seen in FIG. 2, includes a wing nut 32, a spring or lock washer 35 and a bolt 34. Alternatively, the inner ends of arm rods 25 may be pivotally and individually connected to a hub member fixed to the upper, free end of rod 19. Such a hub member 36 is shown in FIG. 3

Although shown in FIG. 1 as vertically oriented, the blade or swatter portions 26 may be oriented at any suitable angle to the horizontal, i.e., at any suitable angle to a plane perpendicular to rod 19, e.g., an angle conventional to fan blades. Further, although shown as having two arms or blades 24, any number of arms or blades 24 may be pivotally attached to the upper, free end of rod 19, provided they are balanced about the center.

FIG. 3 illustrates a modification of the embodiment of FIGS. 1 and 2. As shown in FIG. 3, arms 24 are pivotally attached to a hub 36 fixed to the free end of the exterior portion 21 of rod 19. FIG. 3 also illustrates the positioning of the blade or swatter portion 26 relative to food and beverages on the surface 6 of a table. The arms 24 should be mounted on rod 19 for setting point A (see FIG. 1) to be within 3 to 12″ above the table surface. Ideally, the point A is positioned within 3″ of the tallest items of food or drink on table surface.

In the first embodiment depicted in FIG. 1, the housing 10 consists of upper and lower portions 10B and 10A which are threaded together at 13. The wiring 40 should be sufficiently long to allow separation of 10A from 10B for replacement of battery pack 12.

FIG. 4 shows a second embodiment of the present invention having arms 58 which are freely bendable to fix at least distal end A to within 3-12″ of table surface 6. By “freely bendable” is meant that the arms may be repeatedly bent, without breaking, into a desired shape. Housing 40 contains a battery pack 44 and a motor 48, The battery pack 44 includes a battery holder 46 containing a plurality of D-cell batteries 47. A hinged door 42 on the bottom of housing 40 allows access to the battery pack 44.

A coupling 50 connects a rotational output shaft of the motor 48 to a rod 52 which extends through the housing 40, and optionally a bearing, to a hub 56 fixed to the distal, exterior end of rod 52, for example, by set screw 54. Alternatively the hub 56 may be non-removably fixed to the distal, exterior end of rod 52, e.g., by soldering.

A toggle or other conventional switch 60 with wiring 61 is mounted on housing 40 for turning the device on and off.

The inner ends of a plurality of arms 58 are fixed to hub 56. While arms 58 are shown as pipe cleaners, they may be any conventional wire or rod sufficiently stiff to maintain its arbitrarily fixed shape while rotating but capable of being repeatedly bent and otherwise shaped without breaking, e.g., a rod of a soft aluminum alloy.

In the second embodiment, blades or swatters may be fixed to the distal ends of wires or rods 58, e.g., those shown as 26 in the embodiment of FIG. 1.

The invention may be embodied in other forms without departing from the spirit or essential characteristics thereof. The present embodiments are therefore to be considered in all respects as illustrative and not restrictive.

1. A fly repeller comprising:
a housing;
a motor contained within the housing;
a rod having one end connected to the motor and rotatably driven by the motor, the rod extending from the one end through the housing to a distal end portion exterior to the housing; and
plural arms fixed to and extending laterally from the distal end portion of the rod, wherein the arms are adjustable relative to the horizontal.

2. The fly repeller according to claim 1 wherein the arms are independently adjustable relative to the horizontal.

3. The fly repeller according to claim 1 wherein each of the plural arms is freely bendable to fix a distal end of the arm at any desired distance from a support surface on which the housing is placed.

4. The fly repeller according to claim 2 wherein the arms are pivotally connected to the distal end of the rod.

5. The fly repeller according to claim 1 wherein each arm includes a fan-shaped swatter end portion.

6. A fly repeller comprising:
a housing;
a motor contained within the housing;
a rod having one end connected to the motor and rotatably driven by the motor, the rod extending from the one end through the housing to a distal end portion exterior to the housing; and
plural arms fixed to and extending laterally from the distal end portion of the rod.

7. The fly repeller according to claim 6 wherein each arm includes a fan-shaped swatter end portion.
